(19) United States
(12) Patent Application Publication
(10) Pub. No.: US 2024/0185297 A1
(43) Pub. Date: Jun. 6, 2024

(54) METHODS AND SYSTEMS FOR PROVIDING CONTENT

(71) Applicant: COMCAST CABLE COMMUNICATIONS, LLC, Philadelphia, PA (US)

(72) Inventors: Arpit Mathur, Philadelphia, PA (US); Arun Ravisankar, Philadelphia, PA (US)

(21) Appl. No.: 18/060,729

(22) Filed: Dec. 1, 2022

(51) Int. Cl. G06Q 30/02

(52) U.S. Cl. CPC G06Q 30/0261; G06Q 30/0267; G06Q 30/0269

(57) ABSTRACT

Primary content can be sent to a premises. A gateway associated with the premises may perform content decisioning based on information associated with a user device at the premises.

### BACKGROUND

Current content delivery systems typically provide content and associated advertising in a non-targeted manner. Content providers may have no information about intended recipients other than user location. Thus, advertisements are delivered to users based on the user location, not based on user identity. Consequently, some users may find advertisements irrelevant or inapplicable to their interests. Content delivery system that provided advertisements based solely on user location struggle to convert an impression to a user action (e.g., a purchase) because the advertisement may not be relevant to the individual user.

### SUMMARY

It is to be understood that both the following general description and the following detailed description are exemplary and explanatory only and are not restrictive. In some aspects, provided are methods and systems for targeted content delivery. A device associated with a premises, such as a gateway device, may have access to information about users associated with the premises. Based on this information, the gateway device can make targeted content requests.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating various aspects of an example system;

FIG. 2 is a block diagram illustrating various aspects of an example system;

FIG. 3 is a flowchart illustrating an example method;

FIG. 4 is a flowchart illustrating another example method;

FIG. 5 is a flowchart illustrating another example method; and

FIG. 6 is a block diagram illustrating an example computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

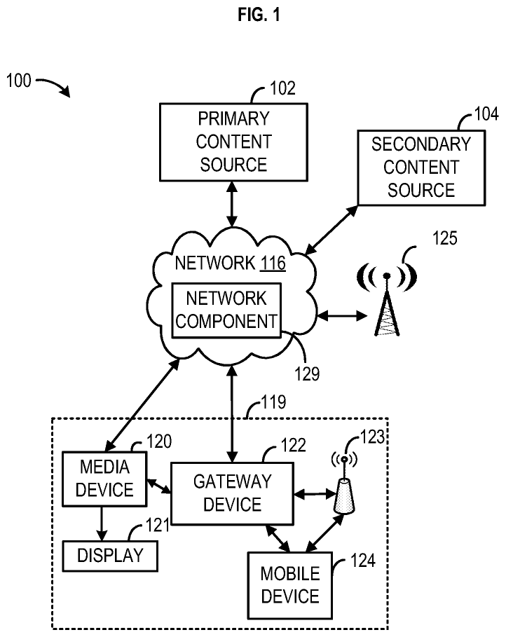

The present disclosure relates to methods and systems for delivering and managing content. FIG. 1 shows a system 100 for content distribution. Those skilled in the art will appreciate that digital equipment and/or analog equipment may be employed. Those skilled in the art will appreciate that provided herein is a functional description and that the respective functions may be performed by software, hardware, or a combination of software and hardware.

The system 100 may comprise a primary content source 102, a secondary content source 104, a media device 120, a gateway device 122, and/or a mobile device 124. Each of the primary content source 102, the secondary content source 104, the media device 120, the gateway device 122, and/or the mobile device 124, can be one or more computing devices, and some or all of the functions performed by these components may at times be performed by a single computing device. The primary content source 102, the secondary content source 104, the media device 120, the gateway device 122, and/or the mobile device 124 may be configured to communicate through a network 116. The network 116 may facilitate sending content to and from any of the one or more device described herein. For example, the network may be configured to facilitate the primary content source 102 and/or the secondary content source 104 sending primary content and/or secondary content to one or more of the media device 120, the gateway device 122, and/or the mobile device 124. The network 116 may be a content delivery network, a content access network, combinations thereof, and the like. The network may be managed (e.g., deployed, serviced) by a content provider, a service provider, combinations thereof, and the like. The network 116 may be an optical fiber network, a coaxial cable network, a hybrid fiber-coaxial network, a wireless network, a satellite system, a direct broadcast system, or any combination thereof. The network 116 can be the Internet. The network 116 may have a network component 129. The network component 129 may be any device, module, combinations thereof, and the like communicatively coupled to the network 116. The network component 129 may be a router, a switch, a splitter, a packager, a gateway, an encoder, a storage device, a multiplexer, a network access location (e.g., tap), physical link, combinations thereof, and the like. The network component 129 may be any device, module, combinations thereof, and the like communicatively coupled to the network 116. The network component 129 may also be a router, a switch, a splitter, a packager, a gateway, an encoder, a storage device, a multiplexer, a network access location (e.g., tap), physical link, combinations thereof, and the like.

The primary content source 102 may be configured to send content (e.g., video, audio, movies, television, games, applications, data, etc.) to one or more devices such as the media device 120, a network component 129, a first access point 123, a mobile device 124, a second access point 125, and/or the media device 120. The primary content source 102 may be configured to send streaming media, such as broadcast content, video on-demand content (e.g., VOD), content recordings, combinations thereof, and the like. For example, the primary content source 102 may be configured to send primary content, via the network 116, to the media device 120.

The media device 120 may be configured to receive the primary content. The media device 120 may comprise a device configured to enable an output device (e.g., a display, a television, a computer or other similar device) to output media (e.g., content). For example, the media device 120 may be configured to receive, decode, transcode, encode, send, and or otherwise process data and send data to, for example, the display device 121. The media device 120 may comprise a demodulator, decoder, frequency tuner, combinations thereof, and the like. The media device 120 may be directly connected to the network (e.g., for communications via in-band and/or out-of-band signals of a content delivery network) and/or connected to the network 116 via the gateway device 122 (e.g., for communications via a packet switched network). The media device 120 may implement one or more applications, such as content viewers, social media applications, news applications, gaming applications, content stores, electronic program guides, combinations thereof, and the like. Those skilled in the art will appreciate that the signal may be demodulated and/or decoded in a variety of equipment, including the gateway device 122, a computer, a TV, a monitor, or a satellite dish. The gateway device 122 may be located at the premises 119. The gateway device 122 may send the content to the media device 120.

The primary content source 102 may be managed by third party content providers, service providers, online content providers, over-the-top content providers, combinations thereof, and the like. The content may be sent based on a subscription, individual item purchase or rental, combinations thereof, and the like. The primary content source 102 may be configured to send the content via a packet switched network path, such as via an IP based connection. The content may comprise a single content item, a portion of a content item (e.g., content fragment), a content stream, a multiplex that includes several content items, combinations thereof, and the like. The content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The content may comprise signaling data.

The secondary content source 104 may be configured to send content (e.g., video, audio, movies, television, games, applications, data, etc.) to one or more devices such as the media device 120, the gateway device 122, the network component 129, the first access point 123, the mobile device 124, and/or a second access point 125. The secondary content source 104 may comprise, for example, a content server such as an advertisement server. The secondary content source 104 may be configured to send secondary content. Secondary content can comprise, for example, advertisements (interactive and/or non-interactive) and/or supplemental content such as behind-the-scenes footage or other related content, supplemental features (applications and/or interfaces) such as transactional applications for shopping and/or gaming applications, metadata, combinations thereof, and the like. The metadata may comprise, for example, demographic data, pricing data, timing data, configuration data, combinations thereof, and the like. For example, the configuration data may include formatting data and other data related to delivering and/or outputting the secondary content.

The secondary content source 104 may be configured to send streaming media, such as broadcast content, video on-demand content (e.g., VOD), content recordings, combinations thereof, and the like. The secondary content source 104 may be managed by third party content providers, service providers, online content providers, over-the-top content providers, combinations thereof, and the like. The content may be sent based on a subscription, individual item purchase or rental, combinations thereof, and the like. The secondary content source 104 may be configured to send the content via a packet switched network path, such as via an IP based connection. The content may comprise a single content item, a portion of a content item (e.g., content fragment), a content stream, a multiplex that includes several content items, combinations thereof, and the like. The content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The content may comprise signaling data.

The gateway device 122 may comprise a local gateway (e.g., router, modem, switch, hub, combinations thereof, and the like) configured to connect (or facilitate a connection between) a local area network (e.g., a LAN) to a wide area network (e.g., a WAN) such as the network 116. The gateway device 122 may be associated with the premises 119. The gateway device may configured to receive incoming data (e.g., data packets or other signals) from the network 116 and route the data to one or more other devices associated with the premises 116 (e.g., the mobile device 124, the media device 120, the display 121, the access point 123, combinations thereof, and the like. The gateway device 122 may be configured to communicate with the network 116. The gateway device 122 may be a modem (e.g., cable modem), a router, a gateway, a switch, a network terminal (e.g., optical network unit), combinations thereof, and the like. The gateway device 122 may be configured for communication with the network 116 via a variety of protocols, such as IP, transmission control protocol, file transfer protocol, session initiation protocol, voice over IP (e.g., VoIP), combinations thereof, and the like. The gateway device 122, for a cable network, may be configured to facilitate network access via a variety of communication protocols and standards, such as Data Over Cable Service Interface Specification (DOCSIS).

The gateway device 122 may be configured to determine a condition associated with the premises 119. For example, the condition associated with the premises 119 may be one or more network connection statuses associated with one or more devices at the premises 119. For example, the one or more network connection statuses may indicate whether or not one or more devices are connected to the network, one or more signal strengths associated with the one o more devices, one or more upload speeds or one or more download speeds associated with the one or more devices, one or more connection histories associated with the one or more devices, combinations thereof, and the like. For example, the gateway device 122 may be configured to determine that both the mobile device 124 and the media device 120 are connected to the same network (e.g., the LAN).

The condition associated with the premises 119 may be the identification of a data packet. For example, the data packet may comprise one or more identifiers. For example, the one or more identifiers may be found in one or more packet headers. The one or more identifiers in the one or more packet headers may indicate one or more origins, one or more destinations, one or more network routes, combinations thereof, and the like. For example, the gateway device 122 may determine that data of a certain type is coming into the LAN or going out of the LAN. For example, the incoming data packet may be an advertisement configured to be viewed on the mobile device 124. Similarly, the gateway device 122 may determine an outgoing data packet is associated with a request for content (e.g., primary content, secondary content) formatted for the mobile device 124.

The condition associated with the premises 119 may be a location (and/or position) of the mobile device 124 with respect to one or more of the media device 120 or the premises 119. For example, a proximity between the mobile device 124 and the media device 120 may be determined by various techniques as is known in the art (e.g., GPS, Bluetooth, infrared). The condition associated with the premises 119 may be a time of day, a day of the week, month, and the like. The condition associated with the premises 119 may be configured by a user.

The condition associated with the premises 119 may comprise any data inbound to the LAN or outbound from the LAN. For example, the condition associated with the premises 119 may comprise the presence or absence of any data such as a device identifier, a user identifier, a data type (e.g., interactive gaming data, streaming television), an indication of content currently output by one or more of the media device 120 and/or the mobile device 124, combinations thereof, and the like. The gateway device 122 may be configured to parse inbound and outbound data packets and determine information associated with the data packets such as one or more device identifiers (e.g., a media device identifier associated with the media device 120, a mobile device identifier associated with the mobile device 124), one or more addresses (e.g., MAC addresses, IP addresses, and the like), user data associated with one or more users of the media device 120 and/or the mobile device 124. For example, the user data may comprise user account information, demographic data, identifying information such as a name, a profile, a birthday, contact information such as a phone number, email addresses, social media profiles such as twitter handles, combinations thereof, and the like.

The gateway device 122 may be configured to determine a content placement opportunity. The content placement opportunity may be associated with the media device, the user device, the gateway device, or any other device, combinations thereof, and the like. The content placement opportunity may comprise an opportunity to present content via a device (e.g., on a display associated with the device or output via an audio component associated with the device). For example, the content placement opportunity may be an area of a display. The area of the display may be available (e.g., unused, without content presently being output in that area of the display, or otherwise available). The content placement opportunity may be an area of a user interface. For example, the content placement opportunity may comprise an unused portion of the user interface being output on a display. The gateway device 122 may be configured to determine the content placement opportunity based on the condition associated with the premises.

For example, based on determining both the media device 120 and the mobile device 124 are connected to the LAN associated with the premises 119, the gateway device may determine a content placement opportunity associated with the media device 120 (and/or the display 121). For example, the content placement opportunity may comprise a navigational menu (e.g., an electronic programing guide or “EPG”), a border of a screen associated with the display device 121, combinations thereof, and the like.

The gateway device 122, based on determining the content placement opportunity, may send a request for content. The gateway device 122 may send the request for content based on the condition associated with the premises. The gateway device 122 may send the request for content to, for example, either or both of the primary content source 102 and/or the secondary content source 104. For example, based on determining the content placement opportunity, and that the mobile device 124 is connected to the LAN, the gateway device 122 may send a request to the secondary content source. The request may comprise a request for secondary content. The request may contain configuration data associated with the content placement opportunity. For example, the configuration data may indicate formatting information, encoding information, definition, aspect ratios, display sizes, pixel data, combinations thereof, and the like. The request may further comprise information associated with the mobile device 124 (and/or a user associated therewith). Information associated with the mobile device 125 may include, but is not limited to, one or more device identifiers, one or more user profiles, one or more model numbers, one or more device types, one or more device use histories, patterns, profiles, one or more connection profiles, combinations thereof, and the like. For example, the request for content may comprise device type information associated with one or more of the mobile device 124 and/or the media device 120, demographic information associated with a user of the mobile device 124, formatting information associated with the content placement opportunity (e.g., size, location, definition, etc. . . . ), combinations thereof, and the like.

The gateway device 122 may be configured to receive the requested content. For example, the gateway device 122 may request, based on an incoming mobile gaming data packet bound for the mobile device 124 and a determination that the mobile device 124 is in proximity to the media device 120, an advertisement associated with the mobile gaming data packet (e.g., an advertisement for a related game). The request may indicate the advertisement should be appropriate for 15 year old male (e.g., demographic information determined based on a user profile associated with the mobile device 124). The gateway device 122 may receive the requested advertisement. The gateway device 122 may send the advertisement to the media device 120 along with output instructions. The output instructions may be configured to cause the media device to output the secondary content. Causing the content to be output via the media device may comprise one or more of: causing the content to be overlaid over other content output via the media device or causing the content to be displayed in a menu output via the media device.

The gateway device 122 may be configured to cause an upstream device to send, to the media device 120, the requested content. For example, the gateway device may send, to the secondary content source 104, an address and/or identifier associated with the media device 120 and cause the secondary device 104 to send the secondary content to the media device 120 via the network 116 or another network (e.g., if the media device 120 is connected to one or more networks).

Returning to the components of system 100, a first access point 123 (e.g., a wireless access point) may be located at the premises 119. The first access point 123 may be configured to provide one or more wireless networks in at least a portion of the premises 119. The first access point 123 may be configured to facilitate access to the network 116 to devices configured with a compatible wireless radio, such as a mobile device 124, the media device 120, the display device 121, or other computing devices (e.g., laptops, sensor devices, security devices). The first access point 123 may be associated with a user managed network (e.g., local area network), a service provider managed network (e.g., public network for users of the service provider), combinations thereof, and the like. It should be noted that in some configurations, some or all of the first access point 123, the gateway device 122, the media device 120, and the display device 121 may be implemented as a single device.

The premises 119 is not necessarily fixed. A user may receive content from the network 116 on the mobile device 124. The mobile device 124 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, combinations thereof, and the like. The mobile device 124 may communicate with a variety of access points (e.g., at different times and locations or simultaneously if within range of multiple access points), such as the first access point 123 or the second access point 125.

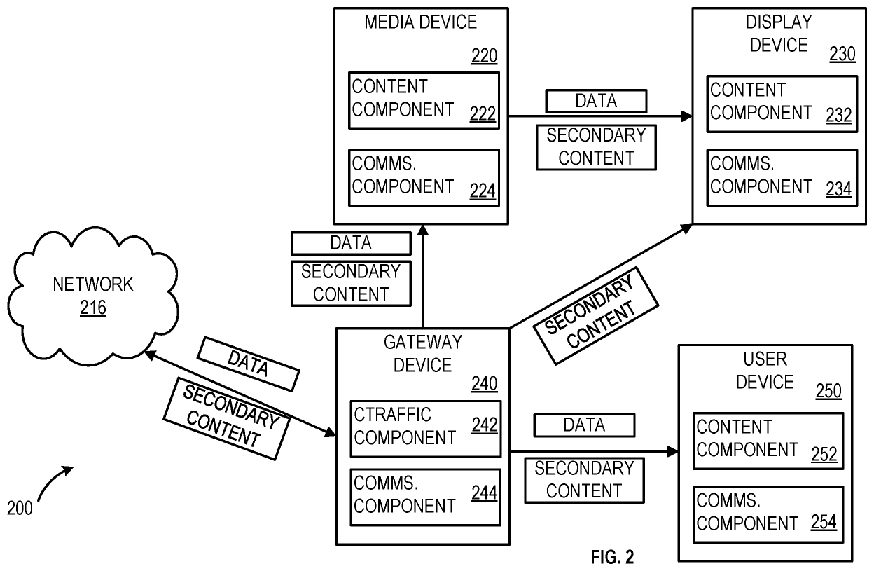

FIG. 2 illustrates various aspects of an example system 200 in which the present methods and systems can operate. The system 200 may include a network 216 (e.g., the network 116), a gateway device 240 (e.g., the gateway device 122), a media device 220 (e.g., the media device 120), a display device 230 (e.g., the display device 121), and a user device 250 (e.g., the mobile device 124).

The gateway device 240 may comprise a traffic component 242 and a communications component 244. The communications component 244 may be configured to facilitate and/or cause communications between and among the media device 220, the display device 230, the user device 250, combinations thereof, and the like. The traffic component 242 may be configured to receive, store, send, encode, decode, transcode, encrypt, decrypt, parse, or otherwise process one or more data packets (e.g., primary content, secondary content, requests therefore, or any other type of data packet). For example, the traffic component 242 may be configured to determine one or more identifiers, one or more addresses, one or more populated fields, one or more populated headers, metadata, or any other data associated with the one or more data packets. For example, the traffic component 242 may be configured to route the one or more data packets to and/or from one or more destination devices connected to the network 216 or another network (e.g., a LAN). The gateway deice 240 may communicate with the media device 220, the display 230, and/or the user device 250 directly or through an access point (not pictured).

The gateway device 240 may be configured to determine, based on network traffic, one or more conditions associated with the premises and cause, based on the condition, one or more actions. For example, the gateway device may detect an inbound data packet destined for the media device 220. The gateway device 240 may detect an outbound data packet sent from the user device 250. Thus, the gateway device 240 may determine both the user device 250 and the media device 220 are connected to same network (e.g., a LAN associated with the gateway and/or an access point).

For example, the inbound data packet destined for the media device may be associated with an electronic programming guide (e.g., an EPG, a channel guide, a navigational menu, combinations thereof, and the like). For example, the gateway device, based on determining the inbound data packet destined for the media device is associated with the EPG, may send a request for content. The request for content may be a request for secondary content (e.g., one or more advertisements, one or more supplemental features, one or more applications, combinations thereof, and the like). The request for content may include, for example demographic information associated with the user device. For example, the demographic information may indicate the user device is associated with a 15 year old male. The request for content may request age appropriate secondary content.

The gateway device 240 may send the request via the network 216 to the secondary content source. The secondary content source may send, to the gateway device 240, secondary content based on the request. For example, the secondary content source may determine an age appropriate advertisement (e.g., an advertisement about an upcoming PG-13 movie). The gateway device 240 may receive the secondary content and send, to the media device 220, the secondary content. The gateway device 240 may cause the media device 220 to output the secondary content.

For example, the outbound data packet sent from the user device may be associated with a request for content. The request for content may be a request for a mobile advertisement associated with content (e.g., a game, a movie, etc. . . . ) being output via the user device 250. Based on the outgoing request for secondary content, the gateway device 240 may determine a content insertion opportunity associated with the EPG destined for the media device 220. The gateway device 240 may determine one or more output parameters associated with the EPG. For example, the gateway device may determine, based on the one or more data packets associated with the EPG, that there is an unused area of a screen associated with the display device 230. Similarly, the gateway device 240, may determine there is no unused area of the display and therefore, the secondary content should be formatted as an overlay.

The gateway device 240 may send, based on the outgoing request for the mobile advertisement, a request for an associated advertisement formatted for a larger device such as the display device 230. The gateway device may send the request for the associated advertisement to the secondary content source via the network 216. The gateway device 240 may receive the associated advertisement, formatted for the display device and may send the associated (e.g., alternative) advertisement to the media device 220. The gateway device 240 may also send output instructions to the media device 220. The output instructions may be configured to cause the media device 220 (and/or the display device 230) to output the alternative advertisement.

Causing output of the second content item may comprise sending the second item to the display device 230. Causing output of the content may comprise causing the display device 230 to display the content. Causing the display device 230 to display the content may comprise one or more of causing the display device 230 to overlay the content on primary content, causing the display device 230 to display the content in a menu or guide, or causing the user device to display the content in a border of the a display associated with the display device 230.

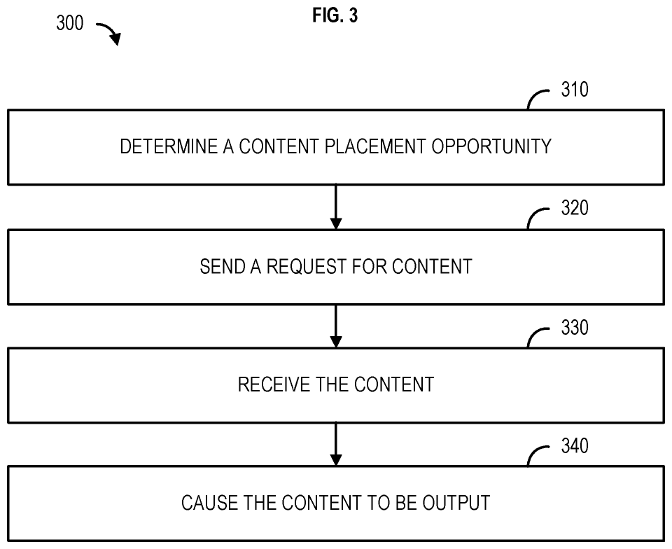

FIG. 3 is a flowchart illustrating an example method 300. The method 300 may be carried out on any one or more devices as described herein. At step 310, a content placement opportunity associated with a media device at a premises may be determined. For example, the content placement opportunity associated with the media device may be determined by a gateway device, a set top box, a content server, or other computing device. The content placement opportunity may be associated with the media device, the user device, the gateway device, or any other device, combinations thereof, and the like. The content placement opportunity may comprise an opportunity to present content via a device (e.g., on a display associated with the device or output via an audio component associated with the device). For example, the content placement opportunity may be an area of a display. The area of the display may be available (e.g., unused, without content presently being output in that area of the display, or otherwise available). For example, the content placement opportunity may be an area of a user interface.

For example, the gateway device may query the media device to determine the placement opportunity. The query may be configured to cause the media device to respond to the query. The query may request content output information. The response may indicate the output information. The output information may comprise channel information, content type information (e.g., an indication of whether the content is streaming content, video-on-demand content, live content, combinations thereof, and the like), menu information (e.g., an indication that an EPG is presently being output by the media device).

The content placement opportunity may be determined based on a condition at the premises. The condition at the premises may comprise a proximity of a user device to the media device, a type of device connected to a network associated with the premises, a type of premises, an inbound content segment, a user input, combinations thereof, and the like. The condition at the premises may comprise for example, determining one or more devices are connected to a network. For example, the network may comprise a WAN and/or LAN and/or a combination thereof. The condition at the premises may be a proximity of one or more devices to each other. For example, determining the proximity of the user device to the media device may comprise determining the user device and the media device are on the same network (e.g., a LAN associated with a premises). For example, determining the proximity of the user device to the media device may comprise determining the user device and the media device (and/or display device) are within a distance of each other. Determining the distance may comprise determining the distance based on RSSI associated any one or more telecommunications protocols such as WiFi, Bluetooth, Bluetooth Low Energy (BLE), infrared, sonar, radar, combinations thereof, and the like. The user device and the media device can be determined to be in proximity when they are connected to a network through the same network device. The user device and the media device can be determined to be in proximity when they are both connected to the same HCT.

In an aspect the user device can be used to display a passcode, such as an alphanumeric code, that the user must enter into the media device to confirm that the user device and the media device are in proximity. Device locations can be determined based on IP addresses assigned to each of the user device and the media device. The user device and/or the media device can comprise a location tracker, such as a global positioning system receiver, a radio frequency transceiver, or the like. A distance between the user device and the media device can be determined based on determined positions for each of the user device and the media device. As an example, when the distance between the user device and the media device is below a predefined threshold (e.g., 25 feet), the first and media devices can be determined to be in proximity to one another.

At 320, a request for content may be sent. For example, the request for content may be sent by the gateway device, the set top box, a user device, or other computing device. The request for content may be a request for primary content and/or a request for secondary content. The gateway device may send the request for content. The request for content may be sent based on the content placement opportunity. The request for content may be sent based on the response to the query received from the media device. For example, the request may include the output information or the like. The request for content may comprise the user device identifier. The request for content may comprise metadata such demographic information, user account information associated with the user device, device information associated with the user device (e.g., device type, make, model, year, combinations thereof, and the like. The request for content may comprise one or more identifiers associated with the gateway device. Sending the request for content may comprise determining demographic information (e.g., associated with the user device identifier or a user or user account associated therewith), and sending, based on the demographic information, the content request. The content request may comprise the demographic information.

At 330, content may be received. For example, the content may be received by the gateway device, the set top box, the user device, or other computing device. For example, the received content may be associated with the content request. The received content may be secondary content. The secondary content may comprise one or more advertisements, one or more supplemental features (e.g., interactive features), one or more applications, combinations thereof, and the like.

At 340, the content may be caused to be output via the media device. For example, the gateway device, the set top box, the user device, a content server, or other computing device may cause the content to be output via the media device. Causing output of the second content item may comprise sending the second item to a display device. Causing output of the content may comprise causing the display device to display the content. Causing the display device to display the content may comprise one or more of causing the display device to overlay the content on primary content, causing the display device to display the content in a menu or guide, or causing the user device to display the content in a border of the a display associated with the display device.

The method 300 may comprise determining information associated with the user device, wherein the information associated with the user device comprises one or more of: an age of a user associated with the user device, a gender of a user associated with the user device, a location of a user associated with the user device, a marital status of a user associated with the user device, a gender identity of a user associated with the user device, financial information of a user associated with the user device. The method 300 may comprise sending a request for secondary content. The method 300 may comprise receiving, based on the request for secondary content, the second content item. The method 300 may comprise determining, based on the first content item, a user device on a network associated with the gateway device, and determining a proximity of the user device to the media device. The method 300 may comprise receiving, based on the second item, an indication of a user input on a user device, and sending, based on the user input, to the user device, one or more of a hyperlink or a third content item.

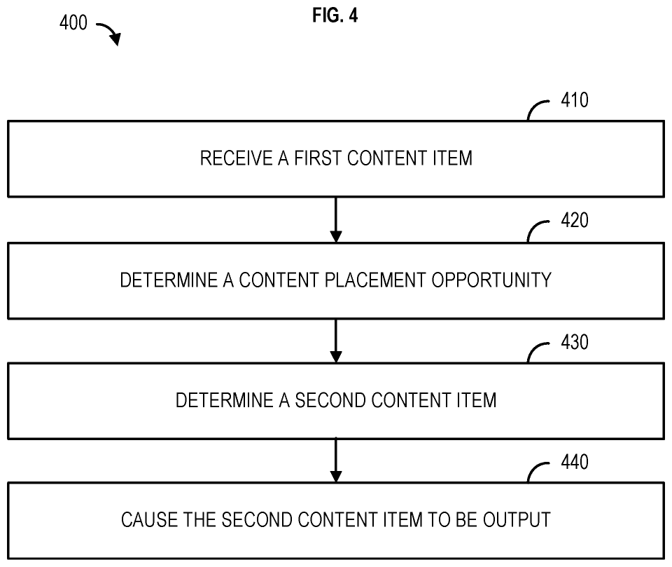

FIG. 4 is a flowchart illustrating another example method 400. The method 400 may be carried out on any one or more devices as described herein. At 410, a first content item may be received. For example, the first content item may be received by a gateway device, set top box, or other computing device. The first content item may be associated with a destination device (e.g., the first content item may be sent to a user device). The user device may be associated with a user device identifier. The user device may be a mobile device such as a tablet or a cell phone. The user device may be a computer such as a desktop computer or laptop.

The user device identifier may be associated with a data packet. The user device identifier may be determined based on the data packet. For example, a gateway device may receive the data packet and determine the user device identifier. The data packet may be associated with one or more of an outgoing request for one or more of primary content or secondary content (e.g., a request for an advertisement), a request for an electronic programming guide, inbound content (e.g., from the WAN to the LAN) such as primary content and/or secondary content. The inbound content may be destined for the user device. For example one or more packet headers and/or packet fields may comprise the user device identifier. The user device identifier may or may not be encrypted. The gateway device may be configured to decrypt an encrypted user device identifier. For example, the user device may be a destination device.

At 420, a content placement opportunity may be determined. For example, the content placement opportunity may be determined the gateway device, set top box, or other computing device. For example, the content placement opportunity may be determined based on receiving the first content item. The content placement opportunity may be associated with a media device, the user device, the gateway device, or any other device, combinations thereof, and the like. The media device may comprise, for example, a set-top-box (STB) or similar device. The content placement opportunity may comprise an opportunity to present content via a device (e.g., on a display associated with the device or output via an audio component associated with the device). For example, the content placement opportunity may be an area of a display. The area of the display may be available (e.g., unused, without content presently being output in that area of the display, or otherwise available).

For example, the gateway device may query the media device to determine the placement opportunity. The query may be configured to cause the media device to respond to the query. The query may request content output information. The response may indicate the output information. The output information may comprise channel information, content type information (e.g., an indication of whether the content is streaming content, video-on-demand content, live content, combinations thereof, and the like), menu information (e.g., an indication that an EPG is presently being output by the media device). Placement opportunities may be based on devices or running applications on those devices. Devices and applications may be registered in a database by the device/application vendor to list opportunity capabilities or may do so at runtime by adding metadata to their requests that the gateway can understand.

At 430, a second content item may be determined. For example, the second content item may be determined by the gateway device, set top box, or other computing device such as a content server. The second content item may be determined based on the content placement opportunity. The second content item may comprise one or more advertisements, one or more supplemental features (e.g., interactive features), one or more applications, combinations thereof, and the like.

The second content item may be determined based on the user device identifier. The second content item may be determined based on data associated with the user device identifier. For example, the second content item may be determined based on account information, demographic information, device information (e.g., device type, make, model, year, etc. . . . ), information associated with one or more applications on the user device, combinations thereof, and the like.

At 440, the second content item may be caused to be output via the media device. For example, the gateway device, the set top box, user device, or other computing device such as a content server may cause the second content item to be output via the media device. Causing output of the second content item may comprise sending the second item to a display device. Causing output of the second content item may comprise causing the display device to display the second content item. Causing the display device to display the content comprises one or more of: causing the display device to overlay the content on primary content, causing the display device to display the content in a menu or guide, or causing the user device to display the content in a border of the a display associated with the display device.

The method may comprise determining information associated with the user device, wherein the information associated with the user device comprises one or more of: an age of a user associated with the user device, a gender of a user associated with the user device, a location of a user associated with the user device, a marital status of a user associated with the user device, a gender identity of a user associated with the user device, financial information of a user associated with the user device. The method may comprise sending a request for secondary content. The method may comprise receiving, based on the request for secondary content, the second content item. The method may comprise determining, based on the first content item, a user device on a network associated with the gateway device, and determining a proximity of the user device to the media device. The method may comprise receiving, based on the second item, an indication of a user input on a user device, and sending, based on the user input, to the user device, one or more of a hyperlink or a third content item.

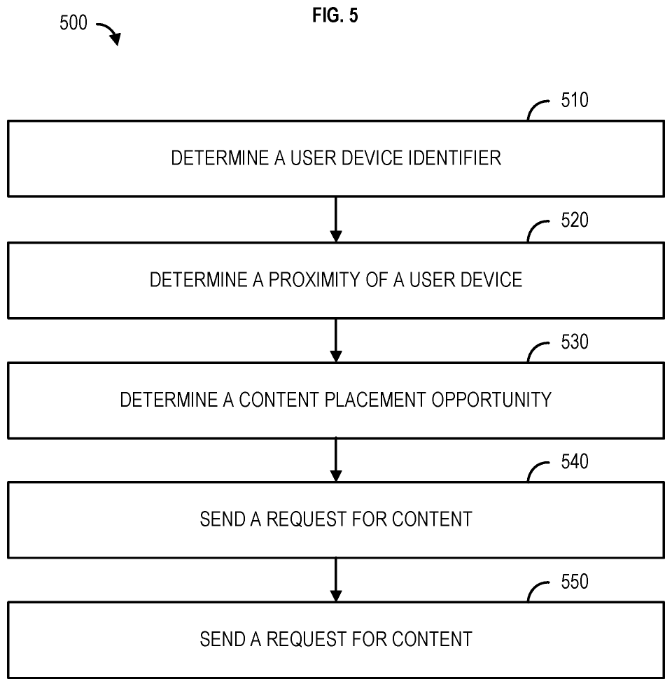

FIG. 5 shows another example method 500. The method 500 may be carried out on any one or more devices as described herein. At 510, a user device identifier may be determined. For example, a gateway device, a set top box, a content server, or other computing device may determine the user device identifier. The user device identifier may be associated with a user device. The user device may be associated with a user device identifier. The user device may be a mobile device such as a tablet or a cell phone. The user device may be a computer such as a desktop computer or laptop. The user device identifier may be associated with a data packet. The user device identifier may be determined based on the data packet. For example, a gateway device may receive the data packet and determine the user device identifier. The data packet may be associated with one or more of an outgoing request for one or more of primary content or secondary content (e.g., a request for an advertisement), a request for an electronic programming guide, inbound content (e.g., from the WAN to the LAN) such as primary content and/or secondary content. The inbound content may be destined for the user device. For example one or more packet headers and/or packet fields may comprise the user device identifier. The user device identifier may or may not be encrypted. The gateway device may be configured to decrypt an encrypted user device identifier. For example, the user device may be a destination device.

At 520, a proximity of a user device may be determined. For example, the gateway device, the set top box, the content server, or other computing device may determine the proximity of the user device. The user device may associated with the user device. The proximity of the user device may indicate the user device is within range of a media device, a display device, one or more other devices, combinations thereof, and the like. For example, determining the proximity of the user device to the media device may comprise determining the user device and the media device are on the same network (e.g., a LAN associated with a premises). For example, determining the proximity of the user device to the media device may comprise determining the user device and the media device (and/or display device) are within a distance of each other. Determining the distance may comprise determining the distance based on RSSI associated any one or more telecommunications protocols such as WiFi, Bluetooth, Bluetooth Low Energy (BLE), infrared, sonar, radar, combinations thereof, and the like. The user device and the media device can be determined to be in proximity when they are connected to a network through the same network device.

The user device and the media device can be determined to be in proximity when they are both connected to the same HCT. In an aspect the user device can be used to display a passcode, such as an alphanumeric code, that the user must enter into the media device to confirm that the user device and the media device are in proximity. In still another aspect, device locations can be determined based on IP addresses assigned to each of the user device and the media device. In another aspect, the user device and/or the media device can comprise a location tracker, such as a global positioning system receiver, a radio frequency transceiver, or the like. A distance between the user device and the media device can be determined based on determined positions for each of the user device and the media device. As an example, when the distance between the user device and the media device is below a predefined threshold (e.g., 25 feet), the first and media devices can be determined to be in proximity to one another.

The data packet may comprise metadata. The metadata may comprise, for example, configuration data, demographic data, pricing data, timing data, combinations thereof, and the like. For example, the configuration data may indicate formatting information, encoding information, definition, aspect ratios, display sizes, pixel data, combinations thereof, and the like.

At 530, a content placement opportunity may be determined. For example, the gateway device, the set top box, the content server, or other computing device may determine the content placement opportunity. The content placement opportunity may be associated with the media device, the user device, the gateway device, or any other device, combinations thereof, and the like. The content placement opportunity may comprise an opportunity to present content via a device (e.g., on a display associated with the device or output via an audio component associated with the device). For example, the content placement opportunity may be an area of a display. The area of the display may be available (e.g., unused, without content presently being output in that area of the display, or otherwise available).

For example, the gateway device may query the media device to determine the placement opportunity. The query may be configured to cause the media device to respond to the query. The query may request content output information. The response may indicate the output information. The output information may comprise channel information, content type information (e.g., an indication of whether the content is streaming content, video-on-demand content, live content, combinations thereof, and the like), menu information (e.g., an indication that an EPG is presently being output by the media device). Capabilities can be registered ahead of time or be discovered in real time based on metadata the application or device adds to network requests, which may be parsed by the gateway device.

At 540, a request for content may be sent. For example, the gateway device, the set top box, the user device, or other computing device may send the request for content. The request for content may be a request for primary content and/or a request for secondary content. The gateway device may send the request for content. The request for content may be sent based on the content placement opportunity. The request for content may be sent based on the response to the query received from the media device. For example, the request may include the output information or the like. The request for content may comprise the user device identifier. The request for content may comprise metadata such demographic information, user account information associated with the user device, device information associated with the user device (e.g., device type, make, model, year, combinations thereof, and the like. The request for content may comprise one or more identifiers associated with the gateway device.

At 550, content may be received. For example, the content may be received by the gateway device, the set top box, the user device, or other computing device. For example, the received content may be associated with the content request. The received content may be secondary content. The secondary content may comprise one or more advertisements, one or more supplemental features (e.g., interactive features), one or more applications, combinations thereof, and the like.

The method may comprise sending the requested content to the media device. The method may comprise causing the display device to output the requested content (e.g., via display). Causing the display device to output the content may comprise one or more of: causing the display device to overlay the content on primary content, causing the display device to display the content in a menu or guide, or causing the user device to display the content in a border of the a display associated with the display device, combinations thereof, and the like.

The method may comprise the media device sending a secondary content display acknowledgement signal when display of secondary content is complete. The secondary content display acknowledgement message can comprise information sufficient to identify the device that displayed the secondary content, and indicate that the content was displayed in its entirety. For example, the secondary content display acknowledgement message can comprise a device ID, session ID, and a flag indicating that the secondary content was displayed in its entirety.

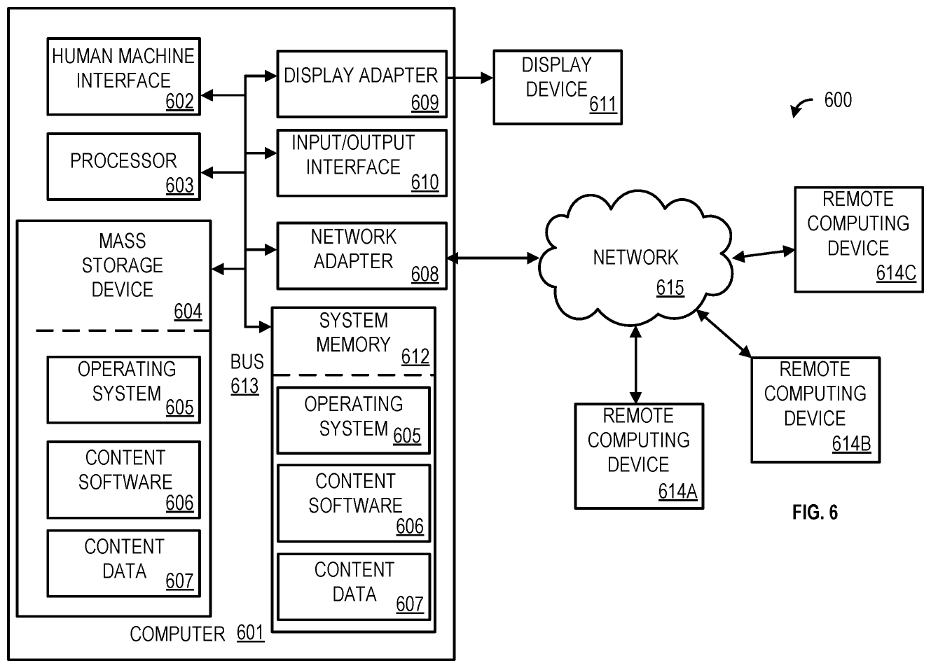

The methods and systems can be implemented on a computer 601 as illustrated in FIG. 6 and described below. By way of example, the gateway device 122 of FIG. 1 can be a computer 601 as illustrated in FIG. 6. Similarly, the methods and systems disclosed can utilize one or more computers to perform one or more functions in one or more locations. FIG. 6 is a block diagram illustrating an example operating environment 600 for performing the disclosed methods. This example operating environment 600 is only an example of an operating environment and is not intended to suggest any limitation as to the scope of use or functionality of operating environment architecture. Neither should the operating environment 600 be interpreted as having any dependency or requirement relating to any one or combination of components illustrated in the example operating environment 600.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage content including memory storage devices.

Further, one skilled in the art will appreciate that the systems and methods disclosed herein can be implemented via a general-purpose computing device in the form of a computer 601. In an aspect, the computer 601 can serve as the content provider. The computer 601 can comprise one or more components, such as one or more processors 603, a system memory 612, and a bus 613 that couples various components of the computer 601 including the one or more processors 603 to the system memory 612. In the case of multiple processors 603, the operating environment 600 can utilize parallel computing.

The bus 613 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and one or more of the components of the computer 601, such as the one or more processors 603, a mass storage device 604, an operating system 605, content software 606, content data 607, a network adapter 608, system memory 612, an Input/Output Interface 610, a display adapter 609, a display device 611, and a human machine interface 602, can be contained within one or more remote computing devices 614A,B,C at physically separate locations, connected through buses of this form, in effect implementing a fully distributed system.

The computer 601 typically comprises a variety of computer readable content. Example readable content can be any available content that is accessible by the computer 601 and comprises, for example and not meant to be limiting, both volatile and non-volatile content, removable and non-removable content. The system memory 612 can comprise computer readable content in the form of volatile memory, such as random access memory (RAM), and/or non-volatile memory, such as read only memory (ROM). The system memory 612 typically can comprise data such as content data 607 and/or program modules such as operating system 605 and content software 606 that are content accessible to and/or are operated on by the one or more processors 603.

In another aspect, the computer 601 can also comprise other removable/non-removable, volatile/non-volatile computer storage content. The mass storage device 604 can provide non-volatile storage of computer code, computer readable instructions, data structures, program modules, and other data for the computer 601. For example, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605 and content software 606. The content data 607 can also be stored on the mass storage device 604. Content data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 615.

In an aspect, the user can enter commands and information into the computer 601 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 603 via a human machine interface 602 that is coupled to the bus 613, but can be connected by other interface and bus structures, such as a parallel port, game port, an IEEE 1394 Port (also known as a Firewire port), a serial port, network adapter 608, and/or a universal serial bus (USB).

In yet another aspect, a display device 611 can also be connected to the bus 613 via an interface, such as a display adapter 609. It is contemplated that the computer 601 can have more than one display adapter 609 and the computer 601 can have more than one display device 611. For example, a display device 611 can be a monitor, an LCD (Liquid Crystal Display), light emitting diode (LED) display, television, smart lens, smart glass, and/or a projector. In addition to the display device 611, other output peripheral devices can comprise components such as speakers (not shown) and a printer (not shown) which can be connected to the computer 601 via Input/Output Interface 610. Any step and/or result of the methods can be output in any form to an output device. Such output can be any form of visual representation, including, but not limited to, textual, graphical, animation, audio, tactile, and the like. The display 611 and computer 601 can be part of one device, or separate devices.

The computer 601 can operate in a networked environment using logical connections to one or more remote computing devices 614A,B,C. By way of example, a remote computing device 614A,B,C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 601 and a remote computing device 614A,B,C can be made via a network 615, such as a local area network (LAN) and/or a general wide area network (WAN). Such network connections can be through a network adapter 608. The network adapter 608 can be implemented in both wired and wireless environments. Such networking environments are conventional and commonplace in dwellings, offices, enterprise-wide computer networks, intranets, and the Internet. In an aspect, the remote computing devices 614A,B,C can serve as first and second devices for displaying content. For example, the remote computing device 614A can be a first device for displaying portions of primary content, and one or more of the remote computing devices 614B,C can be a second device for displaying secondary content. As described above, the secondary content is provided to the second device (e.g., one or more of the remote computing devices 614B,C) in lieu of providing the secondary content to the first device (i.e., the remote computing device 614A). This allows the first device to display multiple portions of primary content contiguously, without in-line breaks for secondary content.

For purposes of illustration, application programs and other executable program components such as the operating system 605 are illustrated herein as discrete blocks, although it is recognized that such programs and components can reside at various times in different storage components of the computing device 601, and are executed by the one or more processors 603 of the computer 601. An implementation of content software 606 can be stored on or transmitted across some form of computer readable content. Any of the disclosed methods can be performed by computer readable instructions embodied on computer readable content. The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
sending, by a gateway device at a premises, based on a content placement opportunity associated with a media device at the premises, a request for secondary content;
receiving the secondary content; and
causing the secondary content to be output via the media device according to the content placement opportunity.

2. The method of claim 1, wherein the request for the secondary content is sent based on one or more of: a proximity of a user device to the media device, a type of device connected to a network associated with the premises, a type of premises, an inbound content segment, or a user input.

3. The method of claim 1, wherein the content placement opportunity comprises a blank area of a display.

4. The method of claim 1, wherein the request for secondary content comprises one or more of: an identifier associated with the gateway device, an identifier associated with the user device, an identifier associated with a user, an identifier associated with the media device, or an identifier associated with the premises.

5. The method of claim 1, wherein causing the secondary content to be output via the media device comprises one or more of: causing the secondary content to be overlaid over other content output via the media device or causing the secondary content to be displayed in a menu output via the media device.

6. The method of claim 1, wherein sending the request for secondary content comprises:
determining demographic information; and
sending, to a content device, based on the demographic information, the request for secondary content.

7. The method of claim 1, further comprising determining, based on one or more of, a proximity of the user device, an inbound content segment, or a user input, a user profile.

8. A method comprising:
receiving, by a gateway device, a first content item requested by a user device, wherein the user device is associated with a user device identifier;
based on receiving the first content item, determining a content placement opportunity associated with a media device;
requesting, based on the user device identifier, a second content item; and
causing, based on the content placement opportunity, the second content item to be output via the media device.

9. The method of claim 8, wherein the first content item comprises a data packet associated with an application running on the user device.

10. The method of claim 8, further comprising determining the user device identifier based on parsing a data packet associated with the content item requested by the user device.

11. The method of claim 8, further comprising determining information associated with the user device, wherein the information associated with the user device comprises one or more of: an age of a user associated with the user device, a gender of the user associated with the user device, a location of the user associated with the user device, a marital status of the user associated with the user device, a gender identity of the user associated with the user device, financial information of the user associated with the user device, and wherein determining the second content item comprises:
sending, based on the information, a request for secondary content; and
receiving, based on the request for secondary content, the second content item.

12. The method of claim 8, wherein causing the second content item to be output comprises sending, to a display device, the second content item; and displaying, in an otherwise blank portion of a display, the second content item.

13. The method of claim 8, further comprising:
determining, based on the first content item, the user device is on a network associated with the gateway device; and
determining a proximity of the user device to the media device.

14. The method of claim 8, further comprising:
receiving an indication of a user input on the user device; and
sending, based on the user input, to the user device, one or more of a hyperlink or a third content item.

15. A method comprising:
determining, by a gateway device at a premises, based on a data packet requested by a user device at the premises, a user device identifier associated with the data packet;
determining, based on the user device identifier, a proximity of the user device associated with the user device identifier to a media device at the premises;
based on determining the proximity of the user device to the media device, determining a content placement opportunity associated with the media device;
sending, based on the content placement opportunity and the user device identifier, a request for secondary content; and
receiving, based on the request for secondary content, the secondary content.

16. The method of claim 15, wherein the data packet is associated with one or more of: an outgoing advertisement request originating from the user device, a request for an electronic programming guide, or an inbound advertisement destined for the user device.

17. The method of claim 15, wherein determining the user device identifier associated with the data packet comprises determining a destination device indicated in a header of the data packet.

18. The method of claim 15, wherein determining the proximity of the user device comprises sending a low energy beacon.

19. The method of claim 15, further comprising causing the media device to send the secondary content to a display device.

20. The method of claim 9, further comprising: causing the display device to overlay the secondary content on primary content.
